(19) United States
(12) Patent Application Publication
(10) Pub. No.: US 2018/0251374 A1
(43) Pub. Date: Sep. 6, 2018

(54) OZONE SUPPLY DEVICE

(71) Applicant: DENSO CORPORATION, Kariya-city, Aichi-pref. (JP)

(72) Inventors: Hideo NARUSE, Kariya-city (JP); Shigeto YAHATA, Kariya-city (JP)

(21) Appl. No.: 15/756,652

(22) PCT Filed: Aug. 25, 2016
(86) PCT No.: PCT/JP2016/074738

§ 371 Date: Mar. 1, 2018

(30) Foreign Application Priority Data
Sep. 8, 2015 (JP) 2015-176931

(51) Int. Cl. C01B 13/11; F01N 3/24

(52) U.S. Cl. CPC C01B 13/11; F01N 3/24

(57) ABSTRACT

An ozone supply device includes an ozonizer, a blower and a housing while the housing serves as an intake duct member. The ozonizer includes electrodes that generate ozone through electric discharge. The blower includes a suction inlet, through which air is drawn, and a discharge outlet, through which the air drawn from the suction inlet is discharged. The blower supplies the air discharged from the discharge outlet to the electrodes and blows the ozone generated through the electric discharge to an exhaust passage. The housing forms a suction air passage that guides the air to the suction inlet. At least a portion of the ozonizer is placed in the suction air passage.

### CROSS REFERENCE TO RELATED APPLICATION

This application is based on and incorporates herein by reference Japanese Patent Application No. 2015-176931 filed on Sep. 8, 2015.

### TECHNICAL FIELD

The present disclosure relates to an ozone supply device that generates ozone and supplies the generated ozone to an exhaust passage of an internal combustion engine.

### BACKGROUND ART

The patent literature 1 discloses a purifier that includes an adsorbent and a reduction catalyst while the adsorbent adsorbs NOx contained in exhaust gas of an internal combustion engine. In this purifier, the adsorbent adsorbs NOx at the time of a low temperature, at which the catalyst is not activated. In contrast, a reducing agent is supplied to the exhaust passage at the time of reaching of the temperature to an activation temperature of the catalyst, so that NOx is reduced on the catalyst and is thereby purified.

Furthermore, the patent literature 1 discloses an ozone supply device that supplies ozone to the exhaust passage on an upstream side of the adsorbent. The ozone supply device includes an ozonizer and a blower. The ozonizer includes electrodes that generate ozone through electric discharge. The blower supplies air to the electrodes and blows the generated ozone to the exhaust passage. When the ozone is supplied to the exhaust passage at the time of the low temperature discussed above, NO of the exhaust gas is oxidized to NO₂. It should be noted that NO₂ can be more easily adsorbed to the adsorbent in comparison to NO. Therefore, the adsorbed amount of NOx on the adsorbent is increased through the supply of the ozone.

Furthermore, this type of ozone supply device has various other usages, which are other than the increasing of the adsorbed amount of NOx on the adsorbent. For example, at the time of regenerating a diesel particulate filter (hereinafter, referred to as a DPF) through combustion of particulates captured by the DPF, when the ozone is supplied to the exhaust passage, the combustion of the particulates can be promoted to promote the regeneration of the DPF.

When the ozone is generated through the electric discharge, heat is generated at the electrodes and the like. Therefore, the generation of the heat needs to be dealt by, for example, cooling the ozonizer through use of a cooling fan. However, an installation space on the vehicle is limited. Therefore, when the cooling fan is installed to the vehicle, a size of the ozone supply device is disadvantageously increased, and thereby it becomes difficult to install the ozone supply device to the vehicle.

### CITATION LIST

### Patent Literature

PATENT LITERATURE 1: JP2012-193620A (corresponding to US2014/0000246A1)

### SUMMARY OF INVENTION

The present disclosure is made in view of the above disadvantage, and it is an objective of the present disclosure to provide an ozone supply device that can improve heat release from an ozonizer while limiting an increase in a size of the ozone supply device.

According to the present disclosure, in order to achieve the above objective, there is provided an ozone supply device to be installed in a vehicle to supply ozone to an exhaust passage of an internal combustion engine, the ozone supply device including:

an ozonizer that includes a plurality of electrodes that generate the ozone through electric discharge;

a blower that includes an intake port, through which air is drawn, and a discharge outlet, through which the air drawn from the intake port is discharged, wherein the blower supplies the air, which is discharged from the discharge outlet, to the plurality of electrodes and blows the ozone, which is generated through the electric discharge, to the exhaust passage; and

an intake duct member that forms an intake air passage, which guides the air to the intake port, wherein at least a portion of the ozonizer is placed in the intake air passage.

According to the ozone supply device described above, at least the portion of the ozonizer is placed in the intake air passage that guides the air to the intake port of the blower, so that the ozonizer is cooled with the intake air. Therefore, the blower, which supplies the ozone to the exhaust passage can be used for cooling of the ozonizer, and thereby it is not required to provide a cooling fan that is dedicated for the cooling of the ozonizer besides the blower. Therefore, the heat release from the ozonizer can be improved while an increase in the size of the ozone supply device is limited.

### BRIEF DESCRIPTION OF DRAWINGS

FIG. 1 is a schematic diagram showing a reducing agent supply device having an ozone supply device according to a first embodiment of the present invention and a combustion system, in which the reducing agent supply device is applied.

FIG. 2 is a diagram schematically showing a cross-section of an ozonizer shown in FIG. 1.

FIG. 3 is a schematic view for explaining a mechanism of generating ozone by electric discharge at the ozonizer shown in FIG. 1.

FIG. 4 is a schematic view for explaining an in-vehicle installation location of the reducing agent supply device shown in FIG. 1.

FIG. 5 is a schematic view for explaining a heat radiating structure of the ozone supply device shown in FIG. 1.

FIG. 6 is a plan view of intake air fins of FIG. 5 taken from an upside of the intake air fins.

FIG. 7 is a view of the intake air fins of FIG. 6 taken from an upstream side in a flow direction of an intake air flow.

FIG. 8 is a view of wind fins of FIG. 5 taken from a downside of the wind fins.

FIG. 9 is a view of the wind fins of FIG. 8 taken from an upstream side in a flow direction of wind applied to a vehicle at a running time of the vehicle.

FIG. 10 is a flowchart showing an operational procedure for controlling an operation of the reducing agent supply device of FIG. 1.

FIG. 11 is a view of intake air fins of a second embodiment of the present invention taken from an upper side of the intake air fins.

FIG. 12 is a view of the intake air fins of FIG. 11 taken from an upstream side in a flow direction of the intake air flow.

FIG. 13 is a schematic view for explaining a heat radiating structure of an ozone supply device according to a third embodiment of the present invention.

FIG. 14 is a schematic view for explaining a heat radiating structure of an ozone supply device according to a fourth embodiment of the present invention.

FIG. 15 is a schematic view for explaining a heat radiating structure of an ozone supply device according to a fifth embodiment of the present invention.

FIG. 16 is a schematic view for explaining a heat radiating structure of an ozone supply device according to a sixth embodiment of the present invention.

FIG. 17 is a schematic diagram showing an ozone supply device according to a seventh embodiment of the present invention and a combustion system, in which the reducing agent supply device is applied.

### DESCRIPTION OF EMBODIMENTS

Hereinafter, various embodiments of the invention will be described with reference to the accompanying drawings. In each of the following embodiments, portions, which are described in a proceeding embodiment(s), will be indicated by the same reference signs and may not be described further for the sake of simplicity. In each of the following embodiments, in a case where only a portion(s) of the structure is described, the rest of the structure may be the same as the one described in the proceeding embodiment(s).

### First Embodiment

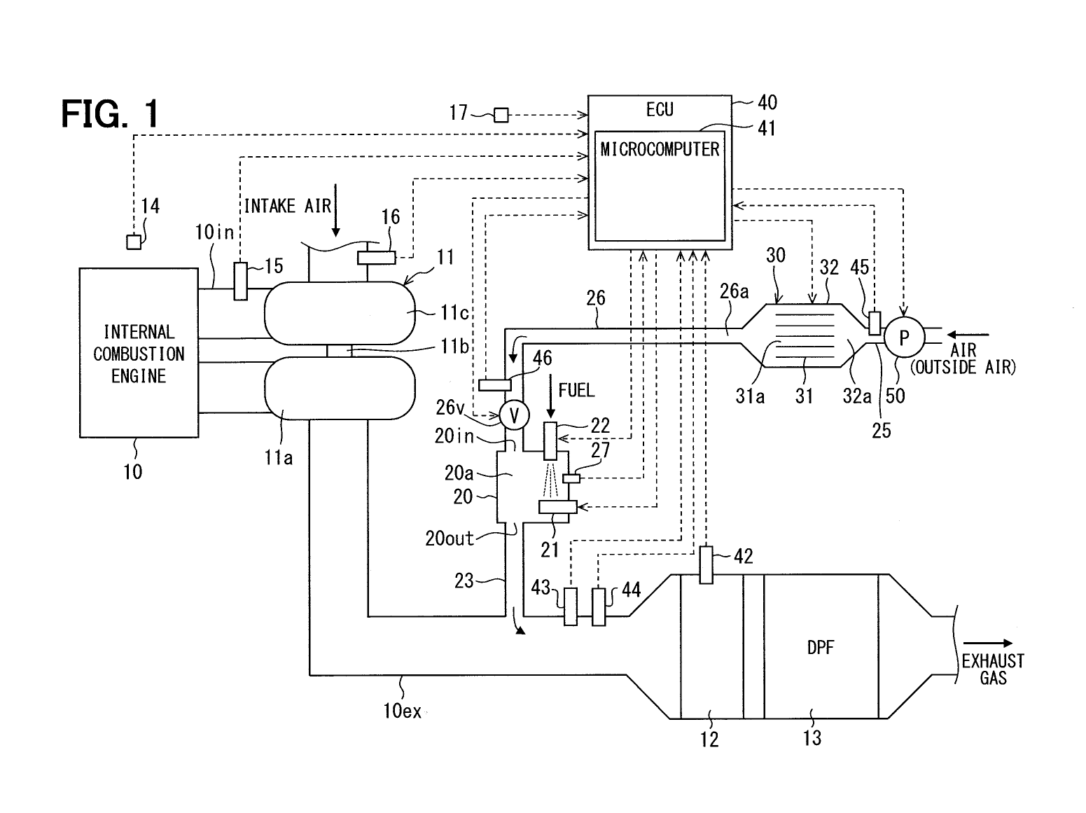

A combustion system of FIG. 1 includes an internal combustion engine (hereinafter referred to as an engine 10), a supercharger 11, an NOx purifier 12, a diesel particulate filter (hereinafter referred to as a DPF 13) and a reducing agent feeder. The combustion system is installed to a vehicle that is driven by an output of the engine 10, which serves as a drive source. The engine 10 is a compression auto-ignition diesel engine, and a fuel, which is combusted in the engine 10, is light oil that is a hydrocarbon compound. The engine 10 is basically operated such that the fuel is combusted in a lean state. Specifically, an air-fuel ratio, which is a ratio of the air suctioned into a combustion chamber relative to the fuel injected into the combustion chamber, is set to implement combustion (i.e., lean combustion) in a state where the air is excessive.

The supercharger 11 includes a turbine 11a, a rotatable shaft 11b and a compressor 11c. The turbine 11a is placed in an exhaust passage 10ex of the engine 10 and is rotated by a kinetic energy of the exhaust gas. The rotatable shaft 11b joins between the turbine 11a and an impeller of the compressor 11c such that a rotational force of the turbine 11a is conducted to the compressor 11c through the rotatable shaft 11b. The compressor 11c is placed in an intake passage 10in of the engine 10 such that the compressor 11c compresses the intake air and supplies the compressed intake air to the engine 10.

A cooling device (not shown), which cools the intake air (pressurized air) that is compressed by the compressor 11c, is placed on a downstream side of the compressor 11c in the intake passage 10in. A flow rate of the compressed air, which is cooled by the cooling device, is adjusted through a throttle valve (not shown), and thereafter the compressed air is distributed to the combustion chambers of the engine 10. The NOx purifier 12 is placed on a downstream side of the turbine 11a in the exhaust passage 10ex, and the DPF 13 is placed on a downstream side of the NOx purifier 12. The DPF 13 collects the fine particles contained in the exhaust gas.

A connecting pipe 23 of the reducing agent feeder is connected to a portion of the exhaust passage 10ex, which is located on an upstream side of the NOx purifier 12. Reformed fuel, which is generated by the reducing agent feeder, is fed as a reducing agent from the connecting pipe 23 to the exhaust passage 10ex. The reformed fuel is partially oxidized hydrocarbon, such as aldehyde, that is formed by partially oxidizing the hydrocarbon compound (the fuel), which is used as the reducing agent. The reducing agent feeder has the function of supplying the ozone from the connecting pipe 23 to the exhaust passage 10ex and thereby implements an ozone supply device.

A housing of the NOx purifier 12 receives a catalytic support, which is shaped into a honeycomb form. A coating material is formed at a surface of the catalytic support, and a reduction catalyst is held by the coating material. At the NOx purifier 12, NOx of the exhaust gas reacts with the reformed fuel on the reduction catalyst, so that NOx is reduced to N₂. Thereby, NOx of the exhaust gas is purified. Although the exhaust gas contains O₂ (oxygen) beside NOx, the reformed fuel selectively reacts with NOx under the presence of O₂.

A reduction catalyst, which adsorbs NOx, is used as the reduction catalyst in the embodiment. Specifically, in a case where a catalyst temperature Tcat is lower than an activation temperature, at which the reduction reaction is made possible, the reduction catalyst implements the function of adsorbing NOx of the exhaust gas. There is provided the NOx purifier 12 that implements the NOx adsorbing function by the reduction catalyst that is formed by, for example, silver-alumina held by the catalytic support. Specifically, there is formed the structure where the silver, which serves as the reduction catalyst, is held by the alumina that is coated at the surface of the catalytic support. NOx, which is adsorbed to the reduction catalyst, is desorbed from the reduction catalyst in a case where the catalyst temperature Tcat is equal to or higher than the activation temperature. The desorbed NOx is reduced by the reformed fuel and is thereby purified. The reduction catalyst has another function of adsorbing reactive oxygen species in addition to NOx adsorbing function.

Next, there will be described the reducing agent feeder, which generates and feeds the reformed fuel or the ozone from the connecting pipe 23 to the exhaust passage 10ex. The reducing agent feeder includes a reaction vessel 20, a heater 21, an injection valve 22, an ozonizer 30, a blower 50, the connecting pipe 23, a supply pipe 26, an opening/closing valve 26v and an electronic control device (hereinafter referred to as an ECU 40).

The ozonizer 30 includes a plurality of electrodes 31, which generate the ozone through electric discharge, and an electrode receiving case 32, which receives the electrodes 31 therein. The electrode receiving case 32 forms a flow passage 32a in an inside of the electrode receiving case 32, and the electrodes 31 are placed in the flow passage 32a. The electrodes 31 are planar plates that are parallel to one another and are opposed to one another. The electrodes 31 include high voltage electrodes, to which a high voltage is applied, and ground electrodes, which have a ground voltage, and these high voltage electrodes and the ground electrodes are alternately arranged. The electric voltage, which is applied to the electrodes 31, is controlled by a microcomputer 41 of the ECU 40. The air, which is blown from the blower 50, flows into the electrode receiving case 32 of the ozonizer 30.

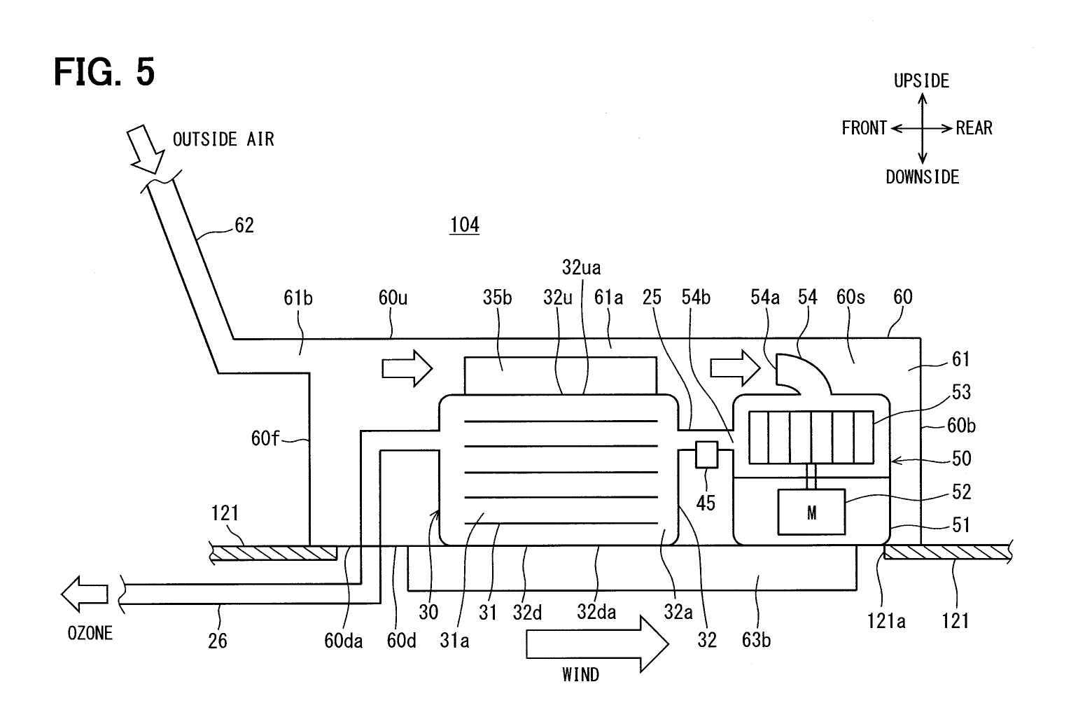

As shown in FIG. 5, the blower 50 includes a blower case 51, an electric motor 52 and a fan 53. The fan 53 is placed in an inside of the blower case 51 and is rotated by the electric motor 52. The blower case 51 includes an intake duct 54 that has an intake port 54a, which suctions the air. The blower case 51 includes a discharge outlet 54b that discharges the air, which is suctioned through the intake port 54a. The blower 50 is a centrifugal blower. The intake port 54a is formed at a location that is opposed to the fan 53 in an axial direction of a rotational axis of the fan 53. The discharge outlet 54b is formed at a location that is opposed to the fan 53 in a radial direction of the rotational axis. When the fan 53 is rotated, the air is drawn into the inside of the blower case 51 through the intake port 54a. Then, the drawn air is compressed by the fan 53 in the inside of the blower case 51 and is discharged through the discharge outlet 54b.

A blower duct 25 is connected to the discharge outlet 54b. The air, which is discharged from the discharge outlet 54b, is supplied to the ozonizer 30 through the blower duct 25. The air, which is discharged from the blower 50, is supplied into the inside of the electrode receiving case 32, i.e., the flow passage 32a, in which the electrodes 31 are placed.

The amount of air to be supplied to the ozonizer 30 by the blower 50 is adjusted when the microcomputer 41 controls the energization of the electric motor 52. For example, the microcomputer 41 controls the amount of electric power supplied to the electric motor 52 through a duty control operation. The air, which is blown to the ozonizer 30, flows into the flow passage 32a of the electrode receiving case 32 and passes through inter-electrode passages 31a, each of which is defined between corresponding adjacent two of the electrodes 31.

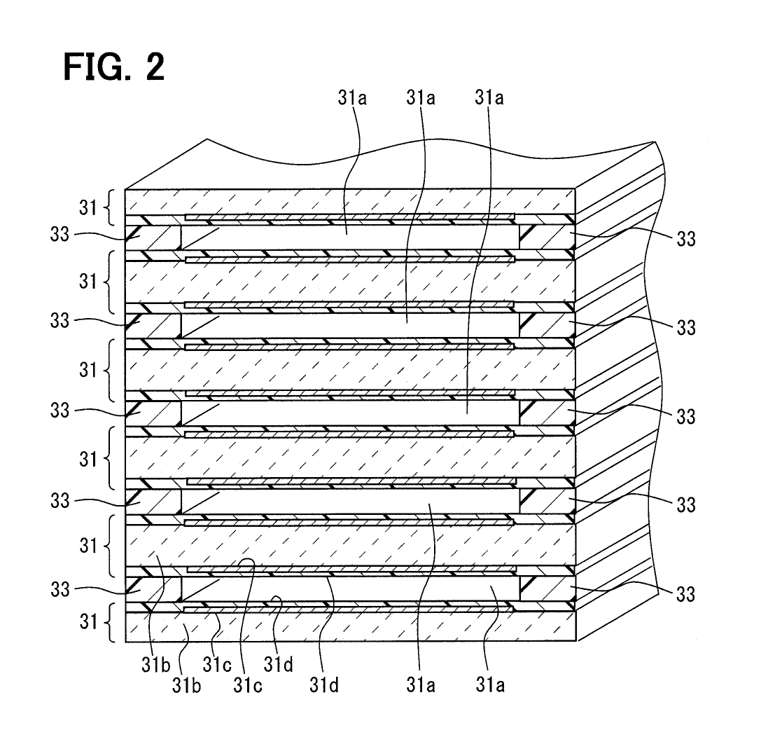

As shown in FIG. 2, each of the electrodes 31 includes a dielectric substrate 31b, electrode plates 31c and dielectric protective films 31d. The dielectric substrate 31b is made of ceramic and holds the electrode plates 31c. When the high voltage is applied to the electrode plates 31c, the electric discharge is made at the inter-electrode passages 31a. Each of the dielectric protective films 31d covers a surface of the corresponding electrode plate 31c from the inter-electrode passage 31a so that the electrode plate 31c is not exposed to the inter-electrode passage 31a.

The electrodes 31 are stacked such that each corresponding one of spacers 33 is interposed between corresponding adjacent two of the electrodes 31. In this way, the electrodes 31, which are respectively shaped into the planar plate form, are opposed to one another and are parallel to one another. Furthermore, each pair of electrodes 31 are spaced from each other by a predetermined distance through the corresponding spacers 33 to form the inter-electrode passage 31a between the electrodes 31. The ozonizer 30 includes a plurality of pairs of electrodes 31.

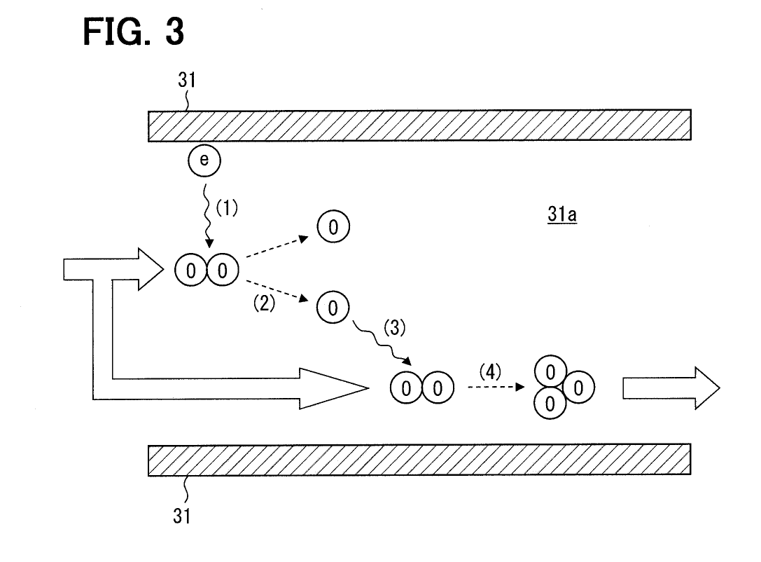

When the voltage is applied to the electrodes 31, electrons, which are discharged from the electrodes 31, collide with oxygen molecules contained in the air that is blown by the blower 50, as indicated by reference sign (1) in FIG. 3. Then, as indicated by reference sign (2), the oxygen molecules are ionized and become a state of reactive oxygen species. As indicated by reference sign (3), the reactive oxygen species react with the oxygen molecules, so that as indicated by reference sigh (4), the reactive oxygen species are oxidized to form the ozone. That is, in a state where the voltage is applied to the electrodes 31, and the blower 50 is operated, the ozone, which is a highly reactive substance, is generated between the electrodes 31. The generated ozone outflows from the inter-electrode passages 31a and the flow passage 32a by the air pressure of the blown air that is blown by the blower 50.

Referring back to FIG. 1, the ozonizer 30 is connected to the reaction vessel 20 through the supply pipe 26. The opening/closing valve 26v, which is electromagnetically driven, is installed in the supply pipe 26. The opening/closing valve 26v is placed on an upstream side of the reaction vessel 20. Opening and closing operations of the opening/closing valve 26v are controlled by the microcomputer 41. Specifically, a valve element of the opening/closing valve 26v is controlled to be switched between a full opening position and a full closing position to open and close a supply passage 26a, which is an inside passage of the supply pipe 26.

Therefore, when the opening/closing valve 26v is opened at the time of driving the blower 50, the air, which includes the ozone outputted from the ozonizer 30, flows through the supply pipe 26, the reaction vessel 20 and the connecting pipe 23 and is discharged into the exhaust passage 10ex. Furthermore, when the opening/closing valve 26v is closed in a state where the exhaust gas pressure is high, it is possible to limit backflow of the exhaust gas into the ozonizer 30 through the supply passage 26a. Thus, it is possible to limit adhesion of foreign objects, such as soot, which are contained in the exhaust gas, to the electrodes 31, and thereby it is possible to limit interference of the electric discharge caused by the adhesion of the foreign objects to the electrodes 31.

The heater 21 and the injection valve 22 are installed to the reaction vessel 20. A reaction chamber 20a, which is communicated with an inlet opening 20in and an outlet opening 20out, is formed in the inside of the reaction vessel 20. The heater 21 includes a heat generating portion that generates heat when the heat generating portion is energized. The energization of the heat generating portion is controlled by the microcomputer 41. Specifically, the amount of electric power supplied to the heat generating portion is controlled by the microcomputer 41 through the duty control operation, so that the amount of heat generated from the heat generating portion is controlled. The heat generating portion is placed in the reaction chamber 20a to heat the fuel, which is injected from the injection valve 22 into the reaction chamber 20a. The temperature of the reaction chamber 20a is sensed by a reaction chamber temperature sensor 27. The reaction chamber temperature sensor 27 outputs a reaction chamber temperature Th, which is sensed by the reaction chamber temperature sensor 27, to the ECU 40.

The injection valve 22 includes a body, an electric actuator and a valve element while the body has injection holes. When energization of the electric actuator is turned on, the valve element is moved to execute a valve opening operation, and thereby the fuel is injected from the injection holes into the reaction chamber 20a. In contrast, when the energization of the electric actuator is turned off, the valve element is moved to execute a valve closing operation, and thereby the fuel injection is stopped. The microcomputer 41 controls the energization of the electric actuator to control the fuel injection amount per unit time. Liquid fuel in a fuel tank (not shown) is supplied to the injection valve 22 by a fuel pump (not shown). The fuel of the fuel tank is also used as the fuel for the combustion, as discussed above. The fuel, which is used for the combustion at the engine 10, and the fuel, which is used as the reducing agent, are the commonly used.

The fuel, which is injected from the injection valve 22 into the reaction chamber 20a, collides against the heater 21 and is heated by the heater 21, so that the heated fuel is evaporated. The evaporated fuel is mixed with the air, which flows from the inlet opening 20in into the reaction chamber 20a. Thus, the gas fuel is partially oxidized by the oxygen of the air, so that the gas fuel is reformed to the partially oxidized hydrocarbon, such as aldehyde. The gas fuel (i.e., the reformed fuel), which is reformed in the above described manner, flows into the exhaust passage 10ex through the connecting pipe 23.

A cool-flame reaction, which will be described in detail below, occurs in the reaction chamber 20a. The cool-flame reaction is a reaction of partially oxidizing the gas fuel by the oxygen of the air that flows into the reaction chamber 20a through the inlet opening 20in. A specific example of the partially oxidized fuel (i.e., the reformed fuel) is a partial oxide (e.g., aldehyde), in which a portion of the fuel (hydrocarbon compound) is oxidized to the aldehyde group (i.e., CHO). When the amount of ozone contained in the air, which is supplied to the reaction chamber 20a, is increased, the partial oxidation of the fuel is promoted. Specifically, the amount of fuel (unreformed fuel), which is not partially oxidized and outflows from the reaction chamber 20a, is reduced.

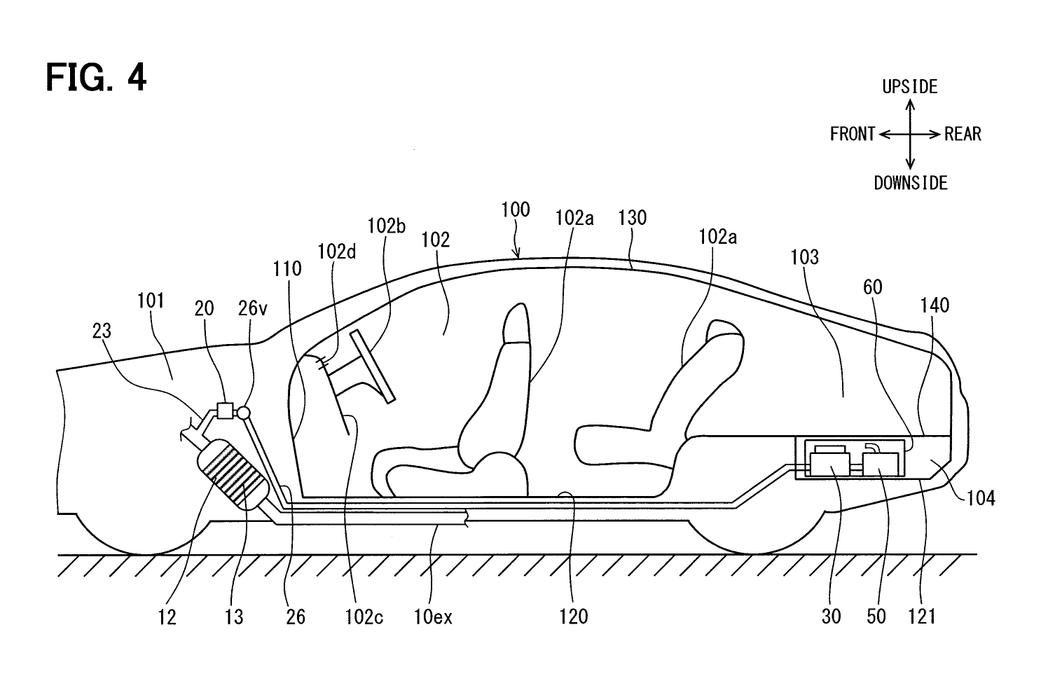

Next, an installation location of the reducing agent feeder in the vehicle 100 will be described with reference to FIG. 4. An arrow, which indicates a front-to-rear direction in FIG. 4, indicates a front-to-rear direction of the vehicle 100. Furthermore, an arrow, which indicates a top-to-bottom direction in FIG. 4, indicates a direction of gravity. The vehicle 100 includes an engine room 101, a cabin 102 and a trunk room 103. The engine 10 is installed in the engine room 101. Seats 102a of vehicle occupants, a steering wheel 102b, and an instrument panel 102c are placed in the cabin 102. The instrument panel 102c has conditioning air outlets 102d that are configured to discharge conditioning air, which is temperature adjusted by an air conditioning device (not shown), into the cabin 102.

The trunk room 103 is a space, in which a luggage of the occupant is placed, and the trunk room 103 is communicated with the cabin 102. A partition plate 140, which partitions the trunk room 103 into an upper space and a lower space, is installed in the trunk room 103. The lower space of the trunk room 103, which is placed on the lower side of the partition plate 140, functions as a storage 104 that can store, for example, a spare tire and tools. The storage 104 corresponds to a compartment of the present disclosure.

The vehicle 100 includes a fire wall 110, a floor plate 120 and a ceiling plate 130, which are plate members made of metal. The fire wall 110 partitions between the engine room 101 and the cabin 102. The floor plate 120 and the ceiling plate 130 respectively form a floor and a ceiling of the cabin 102 and the trunk room 103. Side walls of the cabin 102 and the trunk room 103 are formed by side plates and doors (not shown).

The reaction vessel 20 and the opening/closing valve 26v are placed in the engine room 101. The ozonizer 30 and the blower 50 are placed in the storage 104. Specifically, a housing 60 is placed on a storage floor plate 121 that is a portion of the floor plate 120, which forms the storage 104. The ozonizer 30 and the blower 50 are received in the housing 60. The ozonizer 30 and the blower 50 are placed one after another in the front-to-rear direction of the vehicle. The blower 50 is placed on a vehicle rear side of the ozonizer 30, i.e., is placed on the side that is farther away from the cabin 102.

The supply pipe 26, which supplies the ozone generated by the ozonizer 30 to the reaction vessel 20, extends on the lower side of the floor plate 120 from the storage 104 to the engine room 101. The connecting pipe 23 is placed in the engine room 101. The reformed fuel or the ozone is supplied from the connecting pipe 23 to the exhaust passage 10ex in the engine room 101.

As shown in FIG. 5, the housing 60 is shaped into a box form that is made of a plurality of walls, which surround a space therein. The housing 60 is formed by a resin or metal molded product. The housing 60 is, for example, in a form of a rectangular parallelepiped that is flattened in in the top-to-bottom direction. The housing 60 is shaped into a hexahedron and includes a housing ceiling wall 60u, a housing bottom wall 60d, a pair of housing side walls 60s, a housing front wall 60f and a housing rear wall 60b.

The housing ceiling wall 60u is a wall that forms an upper surface of the housing 60 and is shaped into a rectangle that has long sides that extend in the front-to-rear direction. The housing bottom wall 60d is a wall that forms a lower surface of the housing 60 and is shaped into a form that is similar to the housing ceiling wall 60u.

The pair of housing side walls 60s are walls that respectively form left and right surfaces of the housing 60 and are shaped into an elongated rectangle that has long sides, which extend in the front-to-rear direction. The housing side walls 60s are opposed to each other. The housing front wall 60f and the housing rear wall 60b are walls that form a front surface and a rear surface of the housing 60 and are opposed to each other. The housing front wall 60f and the housing rear wall 60b are walls that are perpendicular to the housing side walls 60s.

A portion of the electrode receiving case 32, which is opposed to the housing ceiling wall 60u, will be referred to as an ozonizer ceiling wall 32u, and a portion of the electrode receiving case 32, which is opposed to the housing bottom wall 60d, will be referred to as an ozonizer bottom wall 32d. The electrode receiving case 32 is shaped into a box form having a plurality of walls, which surround an inside space, and the electrode receiving case 32 is made of a molded product of aluminum plates or iron plates.

The trunk room 103 is communicated with the cabin 102. Therefore, the conditioning air, which is discharged from the conditioning air outlets 102d into the cabin 102, will also flow into the trunk room 103. An outside air inlet 61b is formed at the housing 60, and an outside air introducing duct 62 is connected to the outside air inlet 61b. The outside air introducing duct 62 conducts vehicle outside air (hereinafter, referred to as outside air), which is present at the outside of the trunk room 103 and the cabin 102, i.e., the air, which is not conditioned, to the outside air inlet 61b.

The inside space 61 is hermetically sealed except for the outside air inlet 61b. Therefore, when the blower 50 is operated, the outside air is introduced from the outside air inlet 61b into the inside space 61. Then, the air, which is introduced into the inside space 61, is drawn into the blower case 51 through the intake port 54a.

The outside air inlet 61b and the intake port 54a are placed adjacent to the housing ceiling wall 60u. In this way, the outside air, which is introduced from the outside air inlet 61b, flows along the housing ceiling wall 60u from the front side toward the rear side of the vehicle and is drawn into the intake port 54a. The outside air inlet 61b is formed at a corresponding location of the housing front wall 60f, which is opposed to the intake port 54a.

A portion of the inside space 61, which is located between the housing ceiling wall 60u and the ozonizer ceiling wall 32u, serves as an intake air passage 61a that guides the air into the intake port 54a. The housing ceiling wall 60u and the pair of housing side walls 60s, which constitute a part of the housing 60, serve as an intake duct member, which forms the intake air passage 61a.

Here, it can be said that the outside air, which flows in the intake air passage 61a, flows along the housing ceiling wall 60u, the housing side walls 60s and the ozonizer ceiling wall 32u. Here, when a voltage is applied to the electrodes 31 to cause the electric discharge, the electrodes 31 generate heat. However, this heat is conducted to the electrode receiving case 32 and is thereafter taken away by the outside air that flows along the ozonizer ceiling wall 32u. That is, the ozonizer 30 is cooled by the outside air. An outside surface 32ua of the ozonizer ceiling wall 32u serves as a passage cooling surface that is exposed to the intake air passage 61a and is thereby cooled.

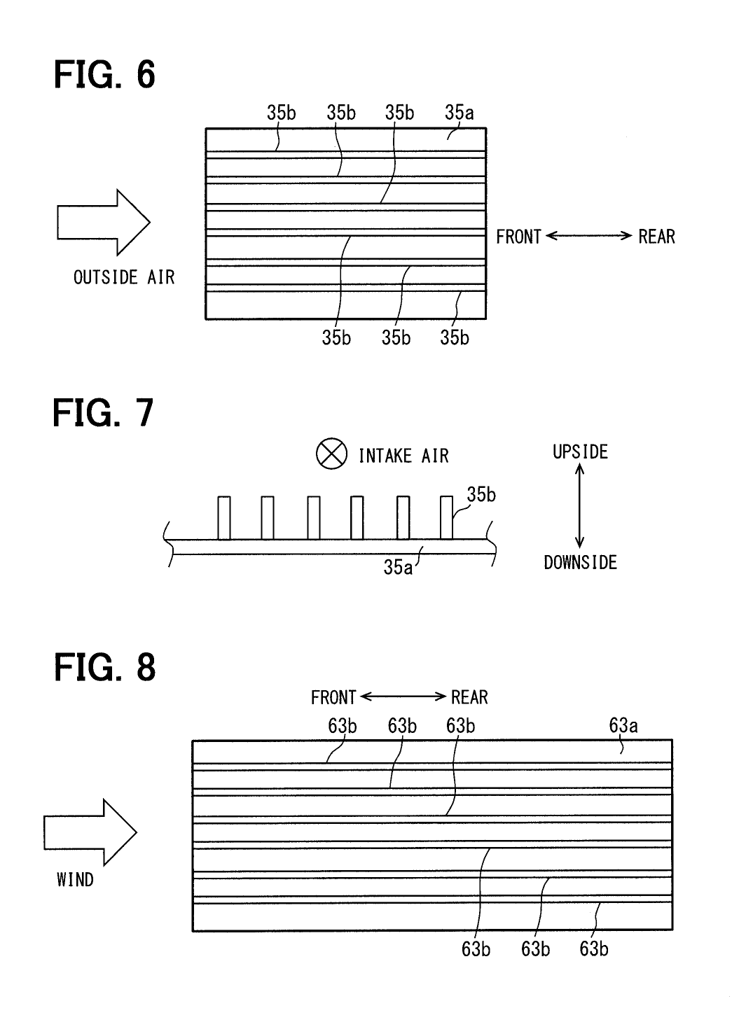

Furthermore, a plurality of intake air fins 35b is formed at the ozonizer ceiling wall 32u. The intake air fins 35b are placed at the intake air passage 61a to release the heat of the electrode receiving case 32 to the intake air. As shown in FIGS. 6 and 7, the intake air fins 35b are made of metal (e.g., aluminum) and are formed integrally with a substrate 35a, and the substrate 35a is fixed to the ozonizer ceiling wall 32u by, for example, welding or bolts. The heat of the electrodes 31 is conducted through the electrode receiving case 32, the substrate 35a and the intake air fins 35b in this order, and then the heat is released from the intake air fins 35b to the outside air. The intake air fins 35b are straight fins that are respectively shaped into a plate form that extends in an extending direction of the intake air passage 61a. At the substrate 35a, the intake air fins 35b are arranged one after another at a predetermined pitch in a direction that intersects the flow direction of the outside air, which flows in the intake air passage 61a.

An opening 121a is formed at the storage floor plate 121. A portion of the housing bottom wall 60d is exposed from the opening 121a to the outside of the vehicle and is thereby exposed to wind that is applied to the vehicle 100 at a running time of the vehicle 100 (hereinafter referred to as “wind applied at the running time of the vehicle 100”). In other words, the housing 60 is installed to the vehicle 100 such that the housing bottom wall 60d is placed at a location where the housing bottom wall 60d is exposed to the wind applied at the running time of the vehicle 100. When the vehicle 100 is running, a portion of the wind, which flows along the storage floor plate 121 at the running time of the vehicle 100, flows along a portion of the housing bottom wall 60d, which is exposed from the opening 121a.

The housing 60 is cooled with the wind applied at the running time of the vehicle 100 by exposing the housing bottom wall 60d to the wind. The ozonizer bottom wall 32d is in contact with the housing bottom wall 60d. Therefore, the heat generated from the electrodes 31 is first conducted to the electrode receiving case 32 and is then conducted from the ozonizer bottom wall 32d to the housing bottom wall 60d where the heat is taken away by the wind applied at the running time of the vehicle 100. That is, the ozonizer 30 is cooled with the wind applied at the running time of the vehicle 100. Thus, the outside surface 32da of the ozonizer bottom wall 32d serves as a contact cooling surface that is in contact with the housing bottom wall 60d and is thereby cooled.

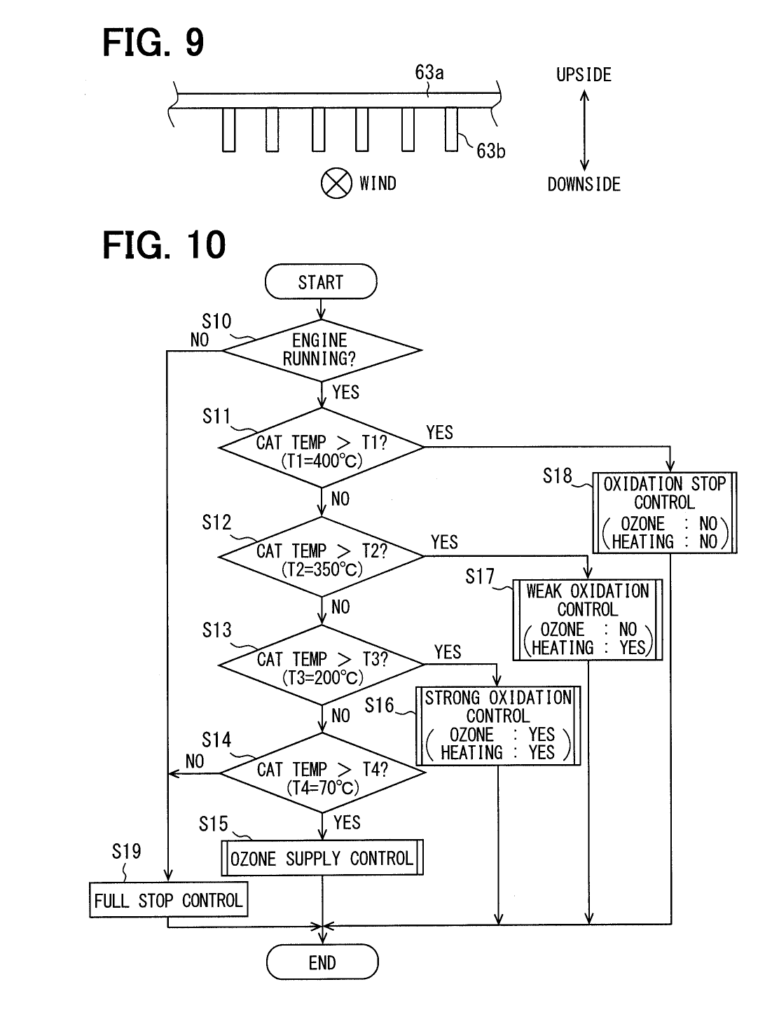

Furthermore, a plurality of wind fins 63b, which are fins for releasing the heat to the wind applied at the running time of the vehicle 100, is formed at the housing bottom wall 60d. With reference to FIGS. 8 and 9, the wind fins 63b are made of metal (e.g., aluminum) and are formed integrally with a substrate 63a, and the substrate 63a is fixed to the housing bottom wall 60d by, for example, welding or bolts. The heat of the electrodes 31 is conducted through the electrode receiving case 32, the substrate 63a and the wind fins 63b in this order, and then the heat is released from the wind fins 63b to the outside air that is the air of the wind applied at the running time of the vehicle 100. The wind fins 63b are straight fins that are respectively shaped into a plate form, which extends in the front-to-rear direction of the vehicle. At the substrate 63a, the wind fins 63b are arranged one after another at a predetermined pitch in a direction that intersects the front-to-rear direction.

In a case where the housing 60 is made of resin, it is desirable to form a portion of the housing 60 by metal to promote release of the heat generated at the ozonizer 30 and the blower 50. Specifically, it is desirable that the portion of the housing 60, which is exposed to the outside of the vehicle through the opening 121a, is made of the metal. For example, it is desirable that the entire housing bottom wall 60d or a portion of the housing bottom wall 60d, which is exposed from the opening 121a, is partially made of the metal.

The microcomputer 41 of the ECU 40 includes a storage device, which stores programs, and a central processing unit, which executes computation processes according to the stored programs. The ECU 40 controls an operation of the engine 10 based on various sensed values, such as an engine rotational speed per unit time and an engine load.

The engine rotational speed is sensed by a crank angle sensor 14 that is installed at a corresponding location, which is adjacent to an output shaft of the engine 10. Physical quantities, which indicate the engine load, may include an intake air pressure, an intake air amount, and an amount of depression of the accelerator pedal. The intake air pressure is sensed by an intake air pressure sensor 15 that is installed at a corresponding location, which is on the downstream side of the compressor 11c in the intake passage 10in. The intake air amount is sensed by an air flow meter 16 that is installed at a corresponding location, which is on an upstream side of the compressor 11c in the intake passage 10in. The amount of depression of the accelerator pedal is sensed by an accelerator sensor 17 that is installed to an accelerator pedal.

The ECU 40 obtains physical quantities that are respectively sensed by a reaction chamber temperature sensor 27, a catalyst temperature sensor 42, an exhaust gas temperature sensor 43, an exhaust gas pressure sensor 44, a blown air amount sensor 45 and a blown air pressure sensor 46 besides the sensed values of the operational state of the engine 10, such as the engine rotational speed and the engine load. The ECU 40 controls the operation of the reducing agent feeder based on these physical quantities.

The catalyst temperature sensor 42 is installed to the NOx purifier 12 and senses the ambient temperature of the reduction catalyst (i.e., a catalyst temperature Tcat). The exhaust gas temperature sensor 43 is installed to the exhaust passage 10ex and senses an exhaust gas temperature. The exhaust gas pressure sensor 44 is installed to the exhaust passage 10ex and senses an exhaust gas pressure. The exhaust gas temperature sensor 43 and the exhaust gas pressure sensor 44 are installed at a corresponding location that is on the upstream side of the NOx purifier 12 and on the downstream side of the turbine 11a in the exhaust passage 10ex. The blown air amount sensor 45 is installed at a corresponding location that is on an upstream side of the ozonizer 30 and on a downstream side of the blower 50 in the supply pipe 26 to sense a blown air amount that is an amount of the air blown by the blower 50. The blown air pressure sensor 46 is installed at a corresponding location that is on the upstream side of the reaction vessel 20 and on a downstream side of the ozonizer 30 in the supply pipe 26 to sense a blown air pressure that is a pressure of the air in the supply pipe 26.

Generally, the ECU 40 controls the operation of the reducing agent feeder in the following manner. Specifically, the ECU 40 selects and executes one of a reducing agent supply control operation and an ozone supply control operation based on the reaction chamber temperature Th. The reducing agent supply control operation is an operation that supplies the reducing agent to the exhaust passage 10ex. The ozone supply control operation is an operation that supplies the ozone to the exhaust passage 10ex. Furthermore, at the time of executing the reducing agent supply control operation, the ECU selects and executes one of a strong oxidation control operation, a weak oxidation control operation and an oxidation stop control operation based on the reaction chamber temperature Th.

Specifically, the microcomputer 41 executes a program shown in FIG. 10 at a predetermined cycle to control the operation of the reducing agent feeder. First of all, at step S10 of FIG. 10, it is determined whether the engine 10 is running. When it is determined that the engine 10 is not running at step S10, it is assumed that NOx, which is a purification subject, is not present in the exhaust passage 10ex. Therefore, the operation proceeds to step S19, at which a full stop control operation for stopping the reducing agent feeder is executed. The full stop control operation is a control operation that stops supply of both of the ozone and the reducing agent to the exhaust passage 10ex. Specifically, the blower 50, the ozonizer 30, the heater 21 and the injection valve 22 are all stopped, and the opening/closing valve 26v is closed.

In contrast, when it is determined that the engine 10 is running at step S10, the operation proceeds to step S11. At step S11, it is determined whether the catalyst temperature Tcat is higher than a first predetermined temperature T1. When it is determined that the catalyst temperature Tcat is lower than the first predetermined temperature T1, the operation proceeds to step S12. At step S12, it is determined whether the catalyst temperature Tcat is higher than a second predetermined temperature T2. When it is determined that the catalyst temperature Tcat is lower than the second predetermined temperature T2 at step S12, the operation proceeds to step S13. At step S13, it is determined whether the catalyst temperature Tcat is higher than a third predetermined temperature T3. When it is determined that the catalyst temperature Tcat is lower than the third predetermined temperature T3 at step S13, the operation proceeds to step S14. At step S14, it is determined whether the catalyst temperature Tcat is higher than a fourth predetermined temperature T4.

The first predetermined temperature T1 and the second predetermined temperature T2 are set to be higher than the third predetermined temperature T3. The first predetermined temperature T1 is set to be higher than the second predetermined temperature T2. For example, in a case where the third predetermined temperature T3 is 200 degrees Celsius, the second predetermined temperature T2 may be set to 350 degrees Celsius, and the first predetermined temperature T1 may be set to 400 degrees Celsius. Here, the third predetermined temperature T3 of the reduction catalyst is the lowest temperature (i.e., an activation temperature) that enables reduction and purification of NOx on the reduction catalyst. The fourth predetermined temperature T4 is the lowest temperature that enables adsorption of the reactive oxygen species on the catalyst. The fourth predetermined temperature T4 is set to be lower than the third predetermined temperature.

In the case where it is determined that the catalyst temperature Tcat is lower than the fourth predetermined temperature T4 through the determinations at steps S11, S12, S13, S14, the operation proceeds to step S19 where the full stop control operation described above is executed. In the case where it is determined that the catalyst temperature Tcat is higher than the fourth predetermined temperature T4 and is lower than the third predetermined temperature T3, the operation proceeds to step S15 where the ozone supply control operation is executed. In the case where it is determined that the catalyst temperature Tcat is higher than the third predetermined temperature T3 and is lower than the second predetermined temperature T2, the operation proceeds to step S16 where the strong oxidation control operation is executed. In the case where it is determined that the catalyst temperature Tcat is higher than the second predetermined temperature T2 and is lower than the first predetermined temperature T1, the operation proceeds to step S17 where the weak oxidation control operation is executed. In the case where it is determined that the catalyst temperature Tcat is higher than the first predetermined temperature T1, the operation proceeds to step S18 where the oxidation stop control operation is executed.

When an equivalence ratio, which is a ratio between the injected fuel and the supplied oxygen, is adjusted within a predetermined range, and the ambient temperature of the injected fuel is adjusted within a predetermined range, the injected fuel will have the cool-flame reaction without reaching to a hot-flame reaction. The hot-flame reaction is a reaction, in which the fuel undergoes complete combustion to produce carbon dioxide and water. The cool-flame reaction is a reaction, in which the fuel is partially oxidized by the oxygen of the air. A specific example of the reformed fuel, which is the fuel partially oxidized in the above-described manner, is a partial oxide that is generated by oxidizing a portion of the fuel, which is a hydrocarbon compound, into aldehyde group (—CHO). Based on this knowledge, the equivalence ratio and the ambient temperature are adjusted such that the reformed fuel is supplied to the catalyst at the strong oxidation control operation of step S16, the weak oxidation control operation of step S17 and the oxidation stop control operation of step S18.

At the strong oxidation control operation of step S16, the ozone, which is generated at the ozonizer 30, the oxygen, which is contained in the air, and the fuel, which is vaporized by the heater 21, are mixed, and the fuel is partially oxidized through the cool-flame reaction in the environment where the ozone is present.

Specifically, a feedback control operation of the heater 21 is executed such that the reaction chamber temperature Th, which is a sensed value of the reaction chamber temperature sensor 27, coincides with a target temperature Ttrg that is predetermined. The target temperature Ttrg is set to implement a corresponding ambient temperature (e.g., 370 degrees Celsius), which results in the cool-flame reaction without reaching to the hot-flame reaction.

Furthermore, at the strong oxidation control operation, a corresponding feeding amount of the reducing agent to be fed to the NOx purifier 12 without causing an excess or a shortage of the reducing agent is computed as a target fuel amount Ftrg at the time of reducing all of NOx that flows into the NOx purifier 12. For example, the target fuel amount Ftrg is set based on an NOx inflow amount, which is the amount of NOx flowing into the NOx purifier 12 per unit time, and the catalyst temperature Tcat. The NOx inflow amount is estimated based on the operational state of the engine 10. When the NOx inflow amount is increased, the target fuel amount Ftrg is increased. Furthermore, the amount of NOx, which is reduced on the reduction catalyst, (i.e., a reducing power) will vary depending on the catalyst temperature Tcat. Therefore, the target fuel amount Ftrg is set in view of a difference in the reducing power caused by the catalyst temperature Tcat. Then, the fuel injection is executed while controlling the operation of the injection valve 22 based on the computed target fuel amount Ftrg.

Furthermore, in the strong oxidation control operation, a target equivalence ratio φtrg is computed based on the reaction chamber temperature Th, so that the cool-flame reaction is generated. Then, a target air amount Atrg is computed based on the target equivalence ratio φtrg and the target fuel amount Ftrg, and the operation of the blower 50 is controlled based on this target air amount Atrg. As discussed above, by controlling the reaction chamber temperature Th and the equivalence ratio, the cool-flame reaction is generated, and the reformed fuel is generated.

Furthermore, in the strong oxidation control operation, the opening/closing valve 26v is opened, and the supply electric power, which is supplied to the ozonizer 30, is controlled based on the concentration of the fuel in the reaction vessel 20. Specifically, a target ozone amount Otrg is computed based on the target fuel amount Ftrg. More specifically, the target ozone amount Otrg is computed such that a ratio of an ozone concentration relative to a fuel concentration in the reaction chamber 20a becomes a predetermined value (e.g., 0.2). For example, the above ratio is set such that the cool-flame reaction is completed within a predetermined time period (e.g., 0.02 seconds). The target ozone amount Otrg is set such that the target ozone amount Otrg is increased when the temperature of the reduction catalyst is reduced, and vice versa.

A target supply electric power amount Ptrg, which is a target amount of electric power supplied to the ozonizer 30, is computed based on the target air amount Atrg and the target ozone amount Otrg. Specifically, when the target air amount Atrg is increased, a residence time of air in the inter-electrode passage 31a decreases, so that the target supply electric power amount Ptrg is increased. Furthermore, when the target ozone amount Otrg is increased, the target supply electric power amount Ptrg is increased. Next, a supply electric power amount, which is an amount of electric power supplied to the ozonizer 30, is controlled based on the target supply electric power amount Ptrg. Specifically, when the target supply electric power amount Ptrg is increased, a duty cycle of the electric power supply to the ozonizer 30 is increased. Alternatively, an interval from an end of the current electric power supply to a start of the next electric power supply is reduced.

By executing the above process, the ozone is generated, and the generated ozone is supplied into the reaction vessel 20. Therefore, the cool-flame reaction can be started earlier, and the cool-flame reaction time period can be shortened. Therefore, even when the size of the reaction vessel 20 is reduced to shorten the residence time of the fuel in the reaction vessel 20, the cool-flame reaction can be completed within the residence time described above. Thus, the size of the reaction vessel 20 can be reduced.

Furthermore, according to the strong oxidation control operation of step S16, the fuel is partially oxidized under the presence of the ozone. In contrast, at the weak oxidation control operation of step S17, the generation of the ozone is stopped by stopping the operation of the ozonizer 30. Thereby, the fuel is partially oxidized under the absence of the ozone. That is, the heater control operation, the fuel injection control operation, the air pump control operation and the valve opening control operation are executed. However, the generation of the ozone is stopped by stopping the supply of the electric power to the ozonizer 30 without executing an electric discharge control operation.

In the weak oxidation control operation of step S17, the fuel is partially oxidized upon heating of the fuel through the heater control operation. In contrast, in the oxidation stop control operation of step S18, the ozonizer 30 and the heater 21 are stopped, so that the generation of the ozone and the heating of the fuel are stopped. In this way, the fuel is not oxidized by the oxygen or the ozone. Thus, the fuel, which is not partially oxidized, is fed into the exhaust passage 10ex and is exposed to the hot exhaust gas in the exhaust passage 10ex or in the NOx purifier 12, so that the fuel is partially oxidized.

In the oxidation stop control operation of step S18, the fuel injection control operation, the air pump control operation and the valve opening control operation are executed. Here, the supply of the electric power to the ozonizer 30 is stopped to stop the generation of the ozone without executing the electric discharge control operation, and the supply of the electric power to the heater 21 is stopped to stop the heating of the fuel without executing the heater control operation.

In the ozone supply control operation of step S15 shown in FIG. 10, the ozonizer 30 is operated to generate the ozone in the state where the supply of the electric power to the heater 21 is stopped, and the supply of the electric power to the injection valve 22 is stopped to stop the fuel injection. The blower 50 is operated in the state where the opening/closing valve 26v is opened, so that the generated ozone is supplied to the exhaust passage 10ex through the supply pipe 26 and the connecting pipe 23. In this way, in the state where the reduction catalyst of the NOx purifier 12 is not activated, NO of the exhaust gas is oxidized to NO₂ by the ozone, and thereby the adsorbed amount of NOx, which is adsorbed at the reduction catalyst, is increased.

In the ozone supply control operation, the ECU 40 obtains the operational state of the engine 10. The operational state includes the engine load, the engine rotational speed and the exhaust gas temperature Tex. The ECU 40 computes an amount of exhaust gas per unit time and an NO concentration in the exhaust gas based on the operational state. Then, the ECU 40 estimates an amount of NO that flows into the NOx purifier 12 per unit time based on the amount of exhaust gas per unit time and the NO concentration in the exhaust gas. The ECU 40 computes an amount of ozone that is required to oxidize NO in the exhaust gas as a target ozone amount Otrg based on the amount of NO estimated in the above-described manner. The electric power supplied to the ozonizer 30 and the amount of blown air from the blower 50 are controlled to supply the target ozone amount Otrg.

When the electric power is supplied to the heater 21 at the time of executing the ozone supply control operation unlike the present embodiment, the ozone is heated and is destroyed. Furthermore, when the fuel injection is executed, the ozone will react with the fuel. In view of the above point, the heating with the heater 21 and the fuel injection are stopped at the time of executing the ozone supply control operation. In this way, the reaction of the ozone with the fuel and the destroy of the ozone by the heating can be avoided, and thereby the generated ozone is directly fed to the exhaust passage 10ex.

Here, when the temperature of the electrodes 31 is increased, the electric power required for the electric discharge is increased. Therefore, it is desirable to limit the temperature increase of the electrodes 31. Furthermore, in the case where the ozonizer 30 is placed in the storage 104 that is communicated with the cabin 102, the heat of the ozonizer 30 is conducted to the cabin 102 to possibly cause an increase in the cooling load of the air conditioning device.

In view of the above disadvantages, according to the present embodiment, the ozonizer 30, which includes the electrodes 31 for generating the ozone through the electric discharge, and the blower 50, which supplies the air to the electrodes 31 and blows the generated ozone to the exhaust passage 10ex, are provided. In addition, the housing 60, which serves as the intake duct member and forms the intake air passage 61a for conducting the air to the intake port 54a of the blower 50, is provided, and at least a portion of the ozonizer 30 is placed in the intake air passage 61a. According to this construction, the ozonizer 30 is cooled by the intake air, which is drawn into the blower 50. Therefore, an increase in the temperature of the electrodes 31 can be limited. Furthermore, the blower 50, which supplies the ozone to the exhaust passage 10ex, can be used for the cooling of the ozonizer. Therefore, it is not required to provide a dedicated cooling fan that is dedicated for the cooling of the ozonizer besides the blower 50. Thus, it is possible to improve the heat radiation performance of the ozonizer 30 while limiting an increase in a size of the ozone supply device.

Furthermore, the intake air, which has the increased temperature upon the heat exchange with the ozonizer 30, is blown into the exhaust passage 10ex. Therefore, an increase in the temperature of the cabin 102 can be limited. Thus, it is possible to reduce a possibility of increasing the cooling load of the air conditioning device that conditions the air of the cabin 102.

Furthermore, in the present embodiment, the housing 60, which receives the ozonizer 30 and the blower 50, is provided, and the part of the housing 60 forms the intake duct member that forms the intake air passage 61a. With this construction, the housing 60, which receives the ozonizer 30 and the blower 50, can be used as the intake duct member. Therefore, it is not required to provide a dedicated intake duct member that is dedicated to form the intake air passage 61a in addition to the housing 60. Thus, it is possible to improve the heat radiation performance of the ozonizer 30 while limiting the increase in the size of the ozone supply device.

Furthermore, in the present embodiment, the inside space 61 of the housing 60 is hermetically sealed except for the outside air inlet 61b, and the ozonizer 30, the blower 50 and the blower duct 25 are received in this inside space 61. Thus, even if the blower duct 25 is detached from the ozonizer 30 or the blower 50 to cause leakage of the ozone, or even if backflow of the ozone to the blower 50 occurs to cause leakage of the ozone from the intake duct 54, leakage of the ozone from the inside space 61 to the storage 104 is limited. Thus, it is possible to limit an increase in the ozone concentration in the atmosphere of the occupant, which would be caused by leakage of the ozone to the cabin 102. Furthermore, even in a case where the vehicle 100 collides, the ozonizer 30 is protected from the collision shock by the housing 60. Therefore, it is possible to limit leakage of the ozone to the cabin 102 upon occurrence of a damage at the ozonizer 30.

Furthermore, according to the present embodiment, the ozonizer 30 includes the electrode receiving case 32, which receives the electrodes 31. The electrode receiving case 32 includes the ozonizer ceiling wall 32u and the ozonizer bottom wall 32d. The ozonizer ceiling wall 32u serves as the passage cooling surface that is exposed to the intake air passage 61a and is thereby cooled. The ozonizer bottom wall 32d serves as the contact cooling surface that is in contact with the housing 60 and is thereby cooled. With this construction, the heat generated at the electrodes 31 is conducted to the electrode receiving case 32. The heat of the electrode receiving case 32 is released to the intake air passage 61a through the ozonizer ceiling wall 32u. Also, the heat of the electrode receiving case 32 is conducted from the ozonizer bottom wall 32d to the housing bottom wall 60d and is thereafter released to the wind applied at the running time of the vehicle 100. Thus, the release of the heat from the ozonizer ceiling wall 32u and the ozonizer bottom wall 32d are promoted, and thereby the temperature decrease of the electrode receiving case 32 is promoted.

Here, in the case where the engine 10 is running in the state where the running of the vehicle 100 is stopped, NOx needs to be purified in a state where the wind, which is applied to the vehicle 100 at the running time of the vehicle 100, is absent. That is, the generation of the ozone is required in the state where the amount of heat released from the housing bottom wall 60d is small. However, in the state where the running of the vehicle 100 is stopped, the amount of NOx emissions is relatively small. Therefore, the required amount of generated ozone is relatively small. Thus, the amount of electric power supplied to the electrodes 31 is relatively small, and thereby the amount of heat generated at the electrodes 31 is relatively small. Thus, even at the time of stopping the running of the vehicle 100, there is a relatively low possibility of that the ozonizer 30 is insufficiently cooled due to insufficient heat release from the housing bottom wall 60d.

Furthermore, according to the present embodiment, the housing 60 is installed to the vehicle 100 at the location where the portion of the housing 60 is exposed to the wind applied at the running time of the vehicle 100. Specifically, the opening 121a is formed at the storage floor plate 121 that is exposed to the wind applied at the running time of the vehicle 100. The housing 60 is installed to the vehicle 100 such that the housing bottom wall 60d is placed at the opening 121a. In this way, the housing 60 is cooled with the wind applied at the running time of the vehicle 100. Thus, it is possible to promote the advantage of limiting the temperature increase of the ozonizer 30, which is received in the housing 60.

Furthermore, the wind fins 63b, which are the fins for releasing the heat to the wind applied at the running time of the vehicle 100, are formed at the housing bottom wall 60d, which is a portion of the housing 60 that is exposed to the wind applied at the running time of the vehicle 100. Therefore, a heat radiating surface area is increased by the wind fins 63b, and thereby it is possible to promote the advantage of cooling the housing 60 by the wind applied at the running time of the vehicle 100.

Furthermore, in the present embodiment, the ozonizer 30 is installed in the storage 104, which is a compartment that is communicated with the cabin 102 of the vehicle 100. The outside air inlet 61b, which introduces the outside air located at the outside of the storage 104, is formed at the housing 60 that serves as the intake duct member. In this way, even when the ozone flows from the downstream side to the upstream side of the blower 50 at the time of stopping the operation of the blower 50, this ozone flows to the outside of the storage 104 through the outside air inlet 61b. Thus, it is possible to reduce the possibility of that the ozone, which flows backward in the above-described manner, leaks into the cabin 102 through the outside air inlet 61b to result in an increase in the ozone concentration of the atmosphere of the occupant.

Furthermore, according to the present embodiment, the ozonizer 30 has the intake air fins 35b placed at the intake air passage 61a to release the heat to the intake air. Therefore, the heat radiating surface area is increased by the intake air fins 35b, and thereby it is possible to promote the advantage of cooling the housing 60 by the intake air that flows in the intake air passage 61a.

Furthermore, according to the present embodiment, the ozone, which is generated by the ozonizer 30, is supplied at the time of generating the cool-flame reaction through the strong oxidation control operation. Therefore, the cool-flame reaction can be started earlier, and the cool-flame reaction time period can be shortened. Therefore, even when the size of the reaction vessel 20 is reduced to shorten the residence time of the fuel in the reaction chamber 20a, the cool-flame reaction can be completed within the residence time described above. Thus, the size of the reaction vessel 20 can be reduced.

### Second Embodiment

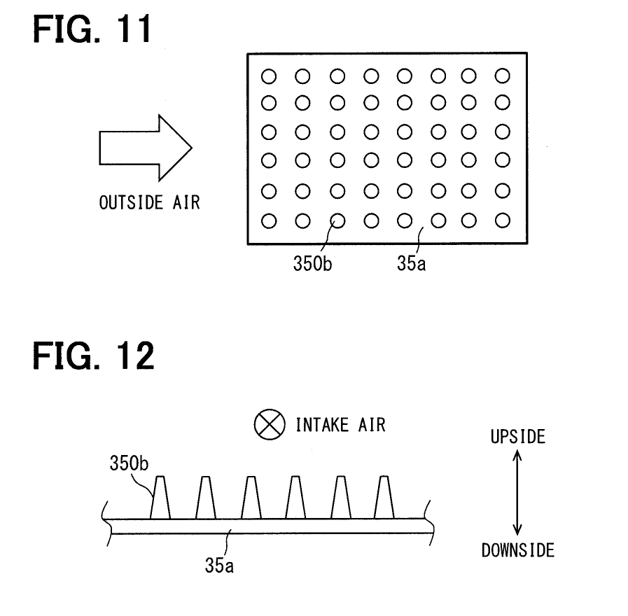

In the first embodiment, as shown in FIGS. 6 and 7, the intake air fins 35b are straight fins that are respectively shaped into the plate form that extends in the flow direction of the intake air. In contrast, in the present embodiment, as shown in FIGS. 11 and 12, the intake air fins 350b are respectively shaped into a pin form. Even with this configuration, like in the case of the straight fins that are respectively shaped into the plate form, the heat radiating surface area of the electrode receiving case 32 can be increased, and thereby it is possible to promote the advantage of cooling the ozonizer 30 by the intake air that flows in the intake air passage 61a.

### Third Embodiment

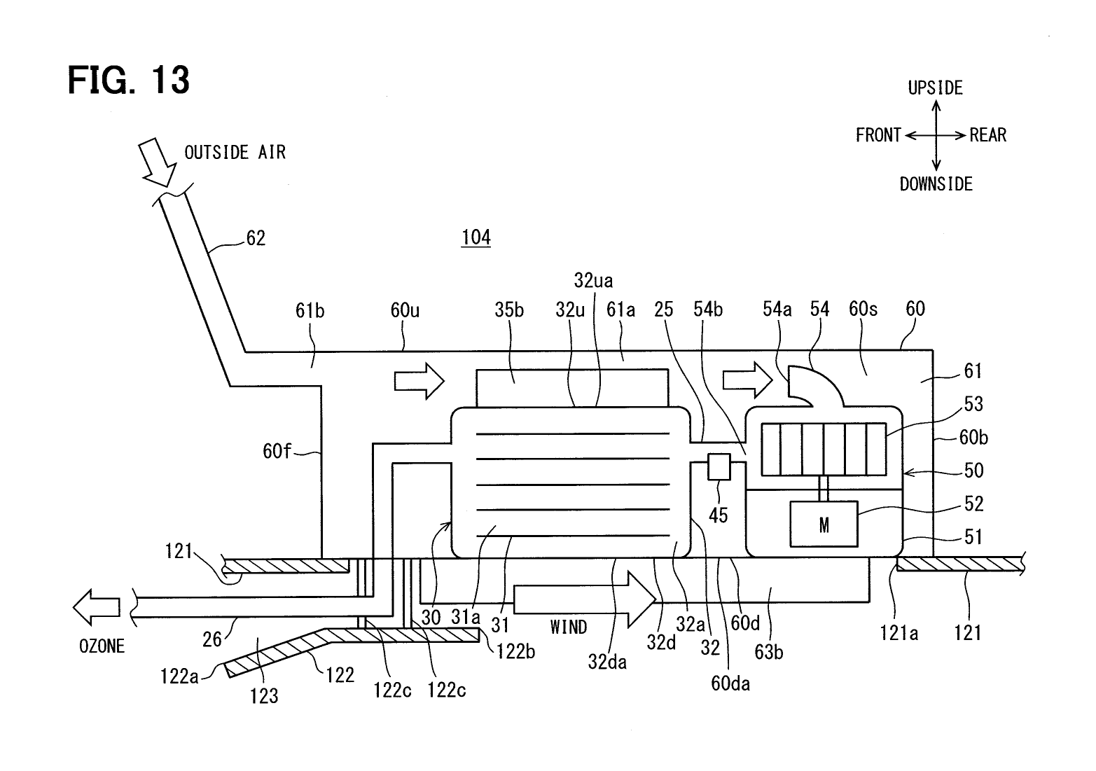

In the present embodiment, a guide plate 122 shown in FIG. 13 is installed to the housing 60. Specifically, brackets 122c, which are installed to the guide plate 122, are installed to the housing bottom wall 60d, so that the guide plate 122 is fixed to the housing bottom wall 60d.

The guide plate 122 functions to collect the wind applied at the running time of the vehicle 100 to a portion of the housing 60, which is exposed to the wind, i.e., a portion of the housing bottom wall 60d, which is exposed from the opening 121a. Specifically, the guide plate 122 regulates and guides the wind, which flows along the storage floor plate 121 at the running time of the vehicle 100, to the opening 121a. The guide plate 122 is a plate member that is arranged to oppose the storage floor plate 121. The wind passage 123, in which the wind applied at the running time of the vehicle 100 flows in the front-to-rear direction of the vehicle, is formed between the guide plate 122 and the storage floor plate 121. A distance, which is measured from an upstream end part 122a of the guide plate 122 to the storage floor plate 121, is larger than a distance, which is measured from a downstream end part 122b of the guide plate 122 to the storage floor plate 121. Therefore, a size of a flow inlet of the wind passage 123 measured in the top-to-bottom direction is larger than a size of a flow outlet of the wind passage 123 measured in the op-to-bottom direction. An opening cross sectional area of the flow inlet is larger than an opening cross sectional area of the flow outlet.

As discussed above, according to the present embodiment, there is provided the guide plate 122 that collects the wind, which is applied at the running time of the vehicle 100, to the portion of the housing 60 exposed to the wind, i.e., the portion of the housing 60 exposed from the opening 121a. Thereby, the wind, which flows along the storage floor plate 121 at the running time of the vehicle 100, is guided to the opening 121a by the guide plate 122. Thus, the amount of wind, which flows along the exposed portion of the housing 60 at the running time of the vehicle 100, is increased. In other words, the amount of wind, which flows to the housing bottom wall 60d and the wind fins 63b at the running time of the vehicle 100, is increased. Thus, the amount of heat released from the ozonizer 30 can be increased.

### Fourth Embodiment

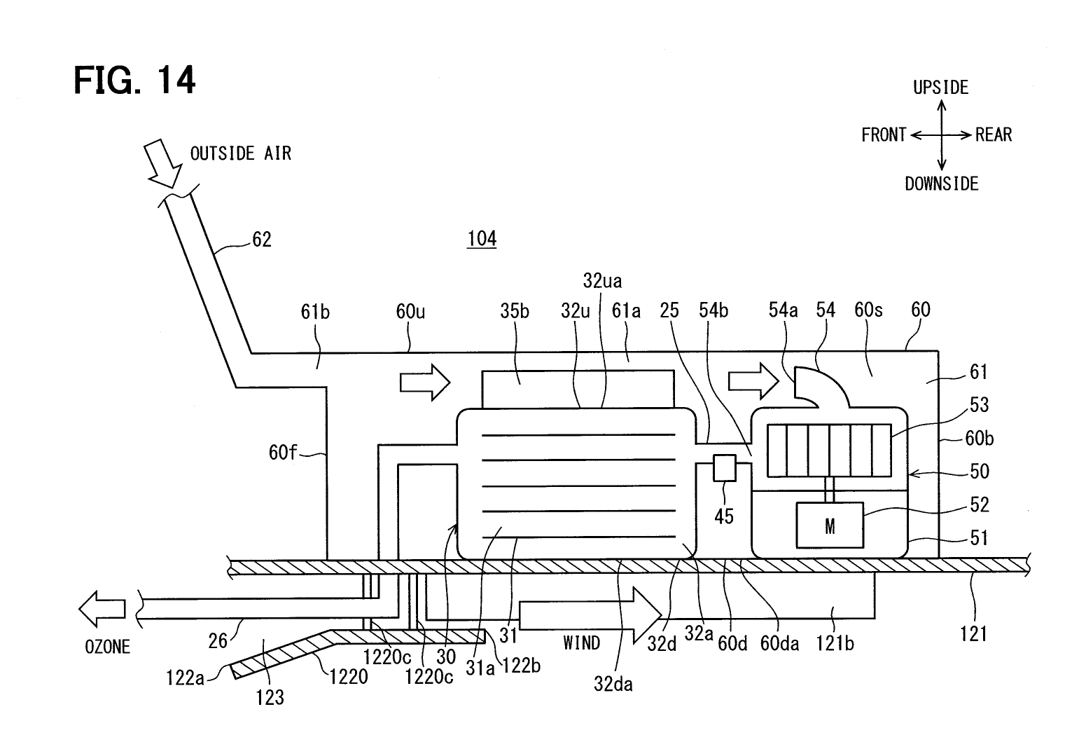

In the first embodiment, as shown in FIG. 5, the opening 121a is formed at the storage floor plate 121, and the portion of the housing bottom wall 60d is exposed from the opening 121a. In contrast, according to the present embodiment, as shown in FIG. 14, the opening at the portion of the storage floor plate 121, which is opposed to the housing bottom wall 60d, is eliminated. Furthermore, the housing bottom wall 60d entirely contacts the storage floor plate 121. Furthermore, a plurality of wind fins 121b, which are fins for releasing the heat to the wind applied at the running time of the vehicle 100, is formed at the storage floor plate 121. A shape, a structure and a material of the respective wind fins 121b are the same as those of the wind fins 63b shown in FIGS. 8 and 9.

The storage floor plate 121 is placed at the corresponding location of the vehicle 100 where the storage floor plate 121 is exposed to the wind applied at the running time of the vehicle 100. Furthermore, the housing bottom wall 60d contacts the storage floor plate 121 that is cooled by the wind applied at the running time of the vehicle 100. Therefore, the heat, which is generated at the electrodes 31, is conducted to the electrode receiving case 32 and is then conducted from the ozonizer bottom wall 32d to the housing bottom wall 60d. Thereafter, this heat is conducted from the housing bottom wall 60d to the storage floor plate 121 and is taken away by the wind applied at the running time of the vehicle 100. That is, an outside surface 60da of the housing bottom wall 60d serves as a housing-side cooling surface that is cooled through contact with the storage floor plate 121 that is the portion of the vehicle 100 exposed to the wind applied at the running time of the vehicle 100.

Furthermore, although the guide plate 122 of the third embodiment discussed above is installed to the housing 60, a guide plate 1220 of the present embodiment is installed to the vehicle 100 through brackets 1220c.

Thereby, in the present embodiment, the housing 60 includes the housing bottom wall 60d that is cooled through the contact with the storage floor plate 121, which is the portion exposed to the wind applied at the running time of the vehicle 100. Therefore, the heat, which is generated at the electrodes 31, is conducted through the electrode receiving case 32, the ozonizer bottom wall 32d, the housing bottom wall 60d and the storage floor plate 121 in this order and is taken away by the wind applied at the running time of the vehicle 100. That is, the ozonizer 30 is cooled by the wind applied at the running time of the vehicle 100. Therefore, the ozonizer is cooled by both of the outside air, which flow in the intake air passage 61a, and the wind applied at the running time of the vehicle 100. Thus, it is possible to promote the advantage of limiting the temperature increase of the ozonizer 30.

Furthermore, in the present embodiment, there is provided the guide plate 1220 that collects the wind, which is applied at the running time of the vehicle 100, to the predetermined air-cooled portion of the vehicle 100 exposed to the wind. Accordingly, the wind, which flows along the storage floor plate 121 at the running time of the vehicle 100, is guided to the predetermined air-cooled portion by the guide plate 1220. Therefore, the amount of the wind, which flows along the air-cooled portion of the storage floor plate 121 at the running time of the vehicle 100, is increased. In other words, the amount of the wind, which flows to the air-cooled portion of the storage floor plate 121 and the wind fins 121b at the running time of the vehicle 100, is increased. Thus, the amount of heat released from the ozonizer 30 can be improved.

### Fifth Embodiment

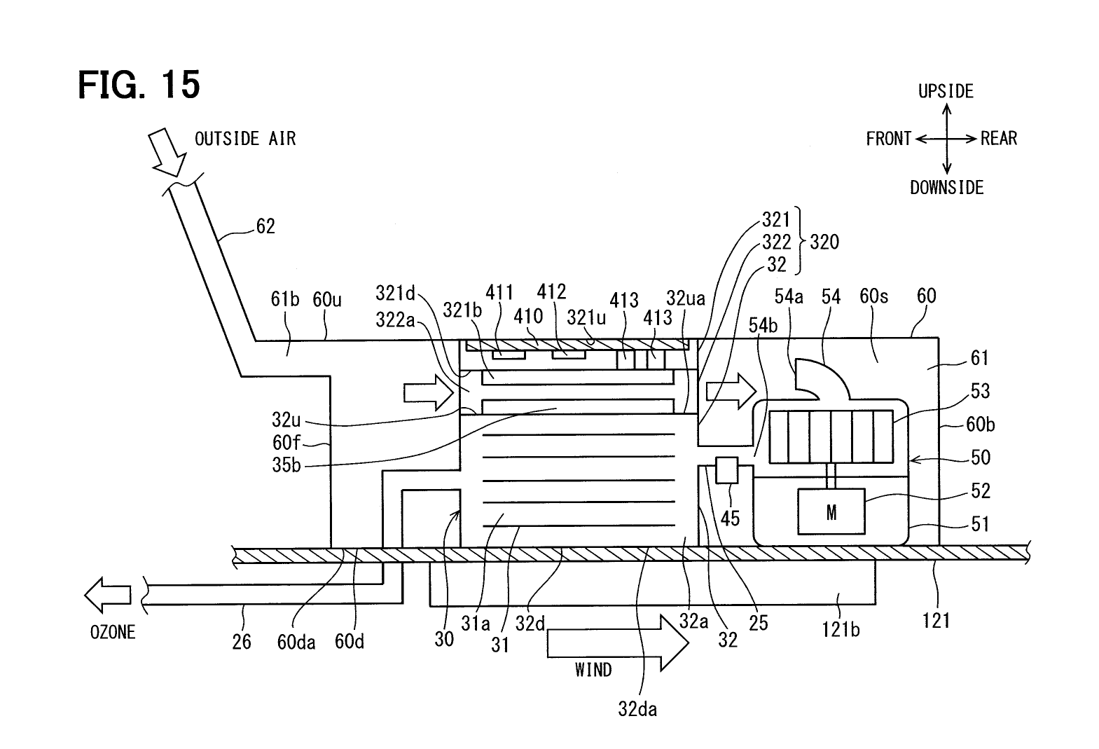

In the present embodiment, as shown in FIG. 15, a circuit board 410, a microcomputer 411, a communication interface 412, switching devices 413 and a circuit case 321 are provided. The microcomputer 411, the communication interface 412 and the switching devices 413 are installed to the circuit board 410. The circuit board 410 is received in the circuit case 321. The switching devices 413 are electronic components, such as power MOS devices, which turn on or off the supply of the electric power to the electrodes 31 and are controlled by the microcomputer 411. The communication interface 412 executes transmission/reception of signals relative to the ECU 40.

The circuit case 321 is placed on the upper side of the electrode receiving case 32. In a state where a bottom wall 321d of the circuit case 321 and the ozonizer ceiling wall 32u are spaced from each other, the circuit case 321 and the electrode receiving case 32 are joined together by a pair of connecting plates 322. The electrode receiving case 32, the circuit case 321 and the connecting plates 322 are made of metal, such as aluminum and are integrated together by a bending process or welding. Hereinafter, the case, which is integrated in the above-described manner, will be referred to as a receiving case 320.

An intake air passage 322a is formed in an inside of the receiving case 320 to guide the outside air, which is drawn through the outside air inlet 61b, to the intake port 54a. Specifically, the intake air passage 322a is formed by a space, which is surrounded by the bottom wall 321d of the circuit case 321, the ozonizer ceiling wall 32u and the pair of connecting plates 322. A portion of the receiving case 320, which forms the intake air passage 322a, corresponds to the intake duct member of the present disclosure.

The switching devices 413 and the circuit board 410 are in contact with the bottom wall 321d of the circuit case 321 or the ceiling wall 321u. In the example shown in FIG. 15, the switching devices 413 are in contact with the bottom wall 321d, and the circuit board 410 is in contact with the ceiling wall 321u. The ceiling wall 321u of the circuit case 321 is in contact with the housing ceiling wall 60u.

Furthermore, a plurality of circuit fins 321b is formed at the bottom wall 321d of the circuit case 321. The circuit fins 321b are placed in the intake air passage 322a and release the heat of the circuit case 321 to the intake air. A shape and a material of the respective circuit fins 321b are the same as those of the respective intake air fins 35b.

Thereby, even in the present embodiment, the ozonizer 30 can be cooled by using the intake air that flows in the intake air passage 322a. Furthermore, in the present embodiment, the circuit case 321 is also cooled by the intake air, so that it is possible to limit the temperature increase of the electronic components, such as the switching devices 413, which generate the heat in response to the supply of the electric power thereto.

### Sixth Embodiment

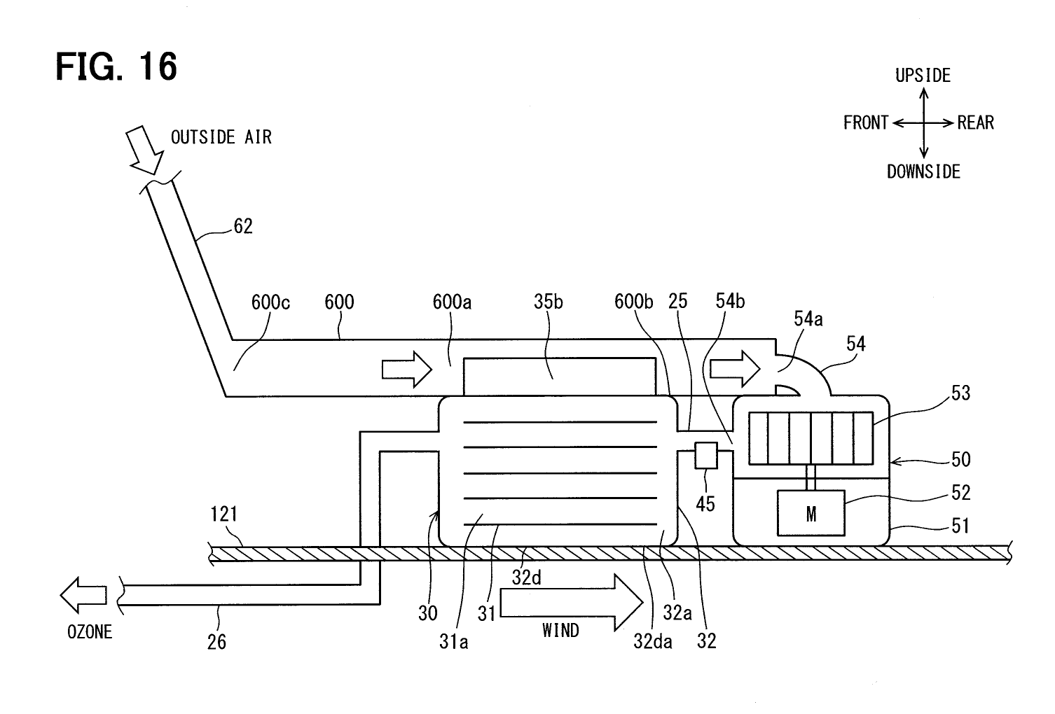

In the embodiment shown in FIG. 5, the housing 60, which receives the ozonizer 30 and the blower 50, is used as the intake duct member that forms the intake air passage 61a. In contrast, according to the present embodiment, as shown in FIG. 16, the housing 60 is eliminated, and there is provided an intake duct member 600 that is dedicated to form the intake air passage 600a.

One end of the intake duct member 600 is connected to the intake duct 54. The outside air introducing duct 62 is connected to an outside air inlet 600c that is the other end of the intake duct member 600. An opening 600b is formed at the intake duct member 600. The ozonizer ceiling wall 32u and the intake air fins 35b are placed at the opening 600b and are exposed to the intake air passage 600a. Therefore, the electrode receiving case 32 is cooled by the intake air that flows in the intake air passage 600a.

Thereby, even in the present embodiment, the ozonizer 30 can be cooled by using the intake air that flows in the intake air passage 600a.

### Seventh Embodiment

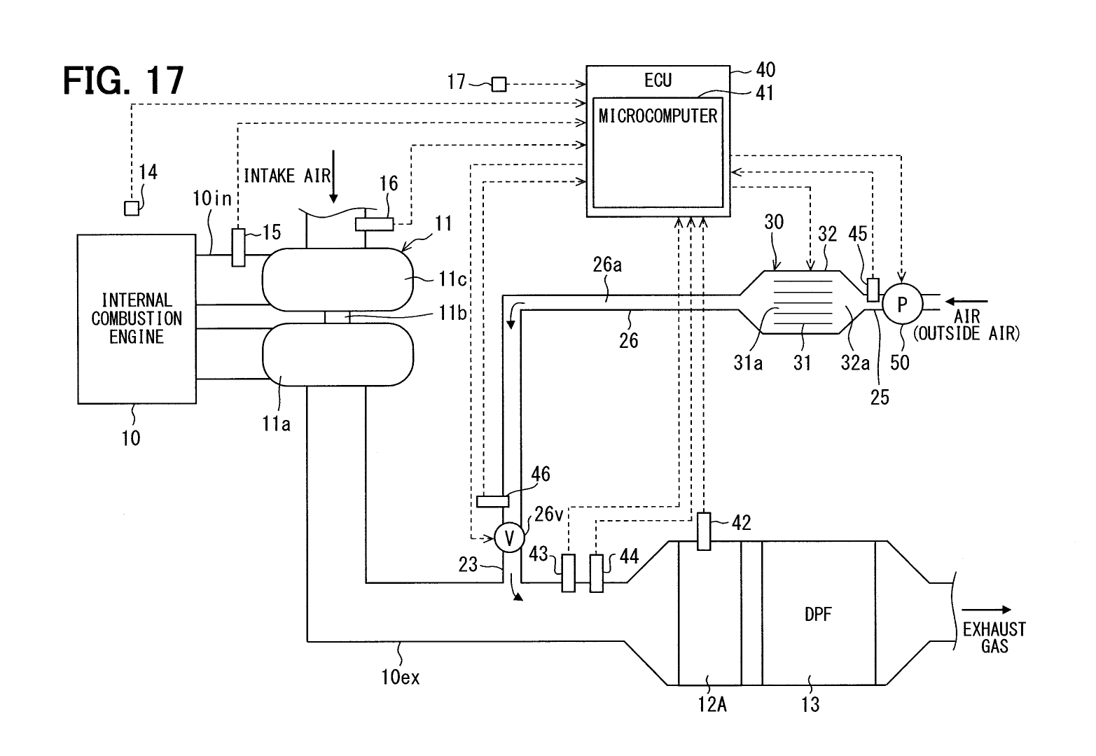

In the first embodiment, the reducing agent feeder, which has the function of supplying the ozone, forms the ozone supply device. In contrast, in the present embodiment, there is provided a device, from which the reaction vessel 20, the heater 21 and the injection valve 22 shown in FIG. 1 are eliminated, and this device forms the ozone supply device shown in FIG. 17. This ozone supply device includes the ozonizer 30, the blower 50, the supply pipe 26, the connecting pipe 23, the opening/closing valve 26v and the ECU 40.

Furthermore, the NOx purifier 12 shown in FIG. 1 uses the reduction catalyst, at which the reducing agent selectively reacts with NOx under the presence of O₂. In contrast, the NOx purifier 12A of the present embodiment uses a reduction catalyst that adsorbs NOx under the lean environment in the presence of O₂ and let the reducing agent react with NOx under the rich environment. A specific example of this type of catalyst, which captures NOx at the lean combustion time, is a storage reduction catalyst that includes platinum and barium held on a catalytic support.

Furthermore, in a control operation of the present embodiment, the process shown in FIG. 10 may be modified as follows. Specifically, the determinations made at steps S11, S12 of FIG. 10 are eliminated, and the control operations at steps S16, S17, S18 of FIG. 10 for controlling the reducing agent supply are eliminated. In the case where it is determined that the catalyst temperature Tcat is higher than the third predetermined temperature T3 at step S13, the full stop control operation of step S19 is executed.

Even in the ozone supply device of the present embodiment, which does not have the function of supplying the reducing agent, the ozonizer 30 can be cooled through use of the intake air by placing at least a portion of the ozonizer 30 in the intake air passage.

### Other Embodiments

The preferred embodiments are described above. However, the present invention should not be limited to the above embodiments, and the above embodiments may be modified in various ways like in the following examples. Besides the combinations of the portions explicitly described in the respective embodiments, undescribed combinations of the various portions of the embodiments are possible as long as there is no difficulty with respect to such combinations.

In the embodiment shown in FIG. 5, the upper end of the respective intake air fins 35b is spaced from the housing ceiling wall 60u. Alternatively, the upper end of the respective intake air fins 35b may be in contact with the housing ceiling wall 60u. In this way, the heat can be transferred from the intake air fins 35b to the housing ceiling wall 60u to promote the cooling of the ozonizer 30.

Furthermore, at least one of the wind fins 63b, 121b, the intake air fins 35b and the circuit fins 321b may be eliminated. Furthermore, the guide plate 122 shown in FIG. 13 and the guide plate 1220 shown in FIG. 14 may be eliminated.

In the embodiment shown in FIG. 4, the ozonizer 30 and the blower 50 are placed in the storage 104 of the trunk room 103. Alternatively, the ozonizer 30 may be placed at another location, such as a location on the lower side of the floor plate 120, which is other the location inside of the storage 104. In other words, the ozonizer 30 may be placed in a space, such as the trunk room 103, which is communicated with the cabin 102. Alternatively, the ozonizer 30 may be placed in a space, such as a space on the lower side of the floor plate 120, which is not communicated with the cabin 102.

In the embodiment shown in FIG. 13, the guide plate 122 is installed to the housing 60. Alternatively, the guide plate 122 may be installed to a portion of the vehicle 100, such as the storage floor plate 121.

The ozone supply device of the present invention may be applied to a combustion system that includes a catalyst that purifies CO and/or HC (predetermined components) of the exhaust gas through oxidation. In such a case, the oxidizing function of the oxidation catalyst can be enhanced by supplying the ozone to the exhaust passage 10ex, thereby effectively used.

In the embodiment shown in FIG. 1, the ozone supply device is applied to the compression auto-ignition diesel engine, and the light oil, which is used as the fuel for the combustion, is used as the reducing agent. Alternatively, the ozone supply device may be applied to a spark ignition type gasoline engine, and gasoline, which is used as fuel for the combustion, may be used as the reducing agent.

The means and/or the function(s), which is (are) provided by the ECU 40 (serving as the control device) may be provided by a software, which is recorded on a tangible storage medium, and a computer, which executes the software. Alternatively, the means and/or the function(s), which is (are) provided by the ECU 40, may be provided only by the software or the hardware or a combination thereof. For example, in a case where the control device is provided by a circuit, which is a hardware, a digital circuit having a plurality of logic circuits, or an analog circuit may be used to provide the means and/or the function(s), which is (are) provided by the ECU 40.

1. An ozone supply device to be installed in a vehicle to supply ozone to an exhaust passage of an internal combustion engine, the ozone supply device comprising:
an ozonizer that includes a plurality of electrodes that generate the ozone through electric discharge;
a blower that includes an intake port, through which air is drawn, and a discharge outlet, through which the air drawn from the intake port is discharged, wherein the blower supplies the air, which is discharged from the discharge outlet, to the plurality of electrodes and blows the ozone, which is generated through the electric discharge, to the exhaust passage; and
an intake duct member that forms an intake air passage, which guides the air to the intake port, wherein at least a portion of the ozonizer is placed in the intake air passage.

2. The ozone supply device according to claim 1, comprising a housing that receives the ozonizer and the blower, wherein a part of the housing forms the intake duct member.

3. The ozone supply device according to claim 2, wherein:
the ozonizer includes an electrode receiving case that receives the plurality of electrodes; and
the electrode receiving case includes:
a passage cooling surface that is exposed in the intake air passage and is thereby cooled through the intake air passage; and
a contact cooling surface that contacts the housing and is thereby cooled through the housing.

4. The ozone supply device according to claim 2, wherein the housing is installed to a corresponding location of the vehicle, at which a portion of the housing is exposed to wind applied to the vehicle at a running time of the vehicle.

5. The ozone supply device according to claim 4, wherein a plurality of wind fins, which release heat to the wind applied to the vehicle at the running time of the vehicle, is formed at the portion of the housing that is exposed to the wind.

6. The ozone supply device according to claim 4, comprising a guide plate that collects the wind, which is applied to the vehicle at the running time of the vehicle, to the portion of the housing that is exposed to the wind.

7. The ozone supply device according to claim 2, wherein the housing includes a housing-side cooling surface that contacts a portion of the vehicle exposed to wind applied to the vehicle at a running time of the vehicle and is thereby cooled through the portion of the vehicle.

8. The ozone supply device according to claim 7, wherein a plurality of wind fins, which release heat to the wind applied to the vehicle at the running time of the vehicle, is formed at the portion of the vehicle exposed to the wind.

9. The ozone supply device according to claim 7, comprising a guide plate that collects the wind, which is applied to the vehicle at the running time of the vehicle, to the portion of the vehicle exposed to the wind.

10. The ozone supply device according to claim 1, wherein:
the ozonizer is installed in a compartment that is communicated with a cabin of the vehicle; and
an outside air inlet, which introduces the air from an outside of the compartment, is formed in the intake duct member.

11. The ozone supply device according to claim 1, wherein the ozonizer includes a plurality of intake air fins, which are placed in the intake air passage and release heat to the drawn air.
